(19) United States
(12) Patent Application Publication
(10) Pub. No.: US 2026/0320355 A1
(43) Pub. Date: Oct. 15, 2026

(54) METHOD, APPARATUS, DEVICE, AND MEDIUM FOR DETERMINING AN OBJECT TO BE RECOMMENDED TO A USER

(71) Applicant: Beijing Zitiao Network Technology Co., Ltd., Beijing (CN)

(72) Inventors: Shaohui RUAN, Beijing (CN); Yimeng BAI, Beijing (CN); Sihao DING, Beijing (CN); Han YAO, Beijing (CN); Danhui GUAN, Beijing (CN)

(21) Appl. No.: 19/648,565

(22) Filed: Apr. 15, 2026

(30) Foreign Application Priority Data
Apr. 15, 2025 (CN) 202510473286.3

(51) Int. Cl. G06N 3/0455

(52) U.S. Cl. CPC G06N 3/0455

(57) ABSTRACT

Methods, apparatuses, devices, and medium for determining an object to be recommended to a user are provided. In a method, a source sequence is obtained, the source sequence comprising at least one source object associated with the user, the at least one source object being comprised in a set of objects. A source feature corresponding to the source sequence is determined using an encoder model. A destination feature corresponding to the source feature is generated using an unconditional diffusion model, the unconditional diffusion model being implemented using a Brownian bridge architecture and describing a relationship between a reference feature of a reference source sequence and a feature of a recommended reference destination object. A destination object matching the destination feature is selected from a plurality of objects in the set of objects.

### CROSS-REFERENCE

The present application claims priority to Chinese Patent Application No. 202510473286.3, filed on Apr. 15, 2025 and entitled “METHOD, APPARATUS, DEVICE, AND MEDIUM FOR DETERMINING AN OBJECT TO BE RECOMMENDED TO A USER”, the entirety of which is incorporated herein by reference.

### FIELD

Implementations of the present disclosure generally relate to object recommendation, and in particular, to a method, an apparatus, a device, and a computer-readable storage medium for determining an object to be recommended to a user based on an unconditional diffusion model.

### BACKGROUND

Diffusion models have been widely used to perform various generative tasks. However, existing technical solutions use conditional diffusion models to perform the recommendation process. In the recommendation process, the interaction history is used as a condition of the diffusion model to obtain a recommended object. However, the performance of conditional diffusion models in recommendation tasks is not satisfactory. At this time, it is expected to provide a more accurate and effective machine learning model and determine the recommended object with higher efficiency.

### SUMMARY

In a first aspect of the present disclosure, a method of determining an object to be recommended to a user is provided. In the method, a source sequence is obtained, the source sequence including at least one source object associated with the user, the at least one source object being included in a set of objects. A source feature corresponding to the source sequence is determined using an encoder model. A destination feature corresponding to the source feature is generated using an unconditional diffusion model, the unconditional diffusion model being implemented using a Brownian bridge architecture and describing a relationship between a reference feature of a reference source sequence and a feature of a recommended reference destination object. A destination object matching the destination feature is selected from a plurality of objects in the set of objects.

In a second aspect of the present disclosure, an apparatus for determining an object to be recommended to a user is provided. The apparatus includes: an obtaining module configured to obtain a source sequence, the source sequence including at least one source object associated with the user, the at least one source object being included in a set of objects; a determination module configured to determine a source feature corresponding to the source sequence using an encoder model; a generation module configured to generate a destination feature corresponding to the source feature using an unconditional diffusion model, the unconditional diffusion model being implemented using a Brownian bridge architecture and describing a relationship between a reference feature of a reference source sequence and a feature of a recommended reference destination object; and a selection module configured to select a destination object matching the destination feature from a plurality of objects in the set of objects.

In a third aspect of the present disclosure, an electronic device is provided. The electronic device includes: at least one processor; and at least one memory coupled to the at least one processor and storing instructions executable by the at least one processor, the instructions, when executed by the at least one processor, causing the electronic device to perform the method of the first aspect.

In a fourth aspect of the present disclosure, a computer-readable storage medium is provided. The computer-readable storage medium stores a computer program which, when executed by a processor, causes the processor to implement the method of the first aspect.

In a fifth aspect of the present disclosure, a computer program product is provided. The computer program product includes a computer program, where the computer program, when executed by a processor, implements the method of the first aspect.

It would be appreciated that the content described in the Summary section of the present disclosure is neither intended to identify key or essential features of the implementations of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the implementations of the present disclosure will become more apparent in the following, in conjunction with the drawings and with reference to the following detailed description. In the drawings, the same or similar reference symbols refer to the same or similar elements, where:

FIG. 1 illustrates a block diagram of using a diffusion model to recommend an object according to an implementation of the present disclosure;

FIG. 2 illustrates a block diagram of an overview of an unconditional diffusion model according to some implementations of the present disclosure;

FIG. 3 illustrates a block diagram of determining an object to be recommended to a user using an unconditional diffusion model according to some implementations of the present disclosure;

FIG. 4 illustrates a block diagram of an unconditional diffusion process implemented based on a Brownian bridge according to some implementations of the present disclosure;

FIG. 5 illustrates a block diagram of an unconditional diffusion process according to some implementations of the present disclosure;

FIG. 6 illustrates a block diagram of algorithms in a forward phase and a backward phase of an unconditional diffusion process according to some implementations of the present disclosure;

FIG. 7 illustrates a flowchart of a method of determining an object to be recommended to a user according to some implementations of the present disclosure;

FIG. 8 illustrates a block diagram of an apparatus for determining an object to be recommended to a user according to some implementations of the present disclosure; and

FIG. 9 illustrates a block diagram of a device capable of implementing a plurality of implementations of the present disclosure.

### DETAILED DESCRIPTION OF EMBODIMENTS

The implementations of the present disclosure will be described in more detail below with reference to the drawings. Although certain implementations of the present disclosure are shown in the drawings, it would be appreciated that the present disclosure may be implemented in various forms and should not be construed as limited to the implementations set forth herein. On the contrary, these implementations are provided for a more thorough and complete understanding of the present disclosure. It would be appreciated that the drawings and implementations of the present disclosure are only for exemplary purposes and are not intended to limit the protection scope of the present disclosure.

In the description of the implementations of the present disclosure, the term “include/comprise” and similar terms should be understood as open-ended inclusions, that is, “include/comprise but not limited to”. The term “based on” should be understood as “at least partially based on”. The term “an implementation” or “the implementation” should be understood as “at least one implementation”. The term “some implementations” should be understood as “at least some implementations”. Other definitions, either explicit or implicit, may also be included below. As used herein, the term “model” may represent an association relationship between various data. For example, the above association relationship may be obtained based on various technical solutions that are currently known and/or will be developed in the future.

It would be appreciated that the data involved in the technical solution (including but not limited to the data itself, acquisition or use of the data) should comply with requirements of corresponding laws, regulations, and related provisions.

It would be appreciated that before using the technical solution disclosed in the embodiments of the present disclosure, the user shall be informed of the type, range of use, use scenarios, etc. of personal information involved in the present disclosure and the authorization of the user shall be obtained in an appropriate manner in accordance with relevant laws and regulations.

For example, in response to receiving an active request from a user, prompt information is sent to the user to clearly prompt the user that the requested operation will require access to and use of the user's personal information. In this way, the user may independently choose, based on the prompt information, whether to provide the personal information to software or hardware, such as an electronic device, an application, a server, or a storage medium, that performs the operations of the technical solution of the present disclosure.

As an optional but non-restrictive implementation, in response to receiving the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It would be appreciated that the above process of notifying and obtaining user authorization is only illustrative and does not constitute a limitation on the implementations of the present disclosure, and other manners that satisfy the relevant laws and regulations may also be applied in the implementations of the present disclosure.

The term “in response to” as used herein represents a state in which a corresponding event occurs or a condition is satisfied. It would be appreciated that an execution timing of a subsequent action performed in response to the event or the condition is not necessarily strongly correlated with a time when the event occurs or the condition is satisfied. For example, in some cases, the subsequent action may be performed immediately when the event occurs or the condition is satisfied, while in other cases, the subsequent action may be performed after a period of time after the event occurs or the condition is satisfied.

### Example Environment

Diffusion models have been widely used to perform various generative tasks, and recommendation algorithms based on diffusion models have become an important research direction for machine learning models. Existing technical solutions use conditional diffusion models to perform the recommendation process. For ease of description, the video recommendation process will be described below only by taking an example of recommending a video to a user in a video playback application. The user may play videos in the video playback application, and a new video may be recommended to the user based on the user's playback history (for example, a sequence of videos that have been played).

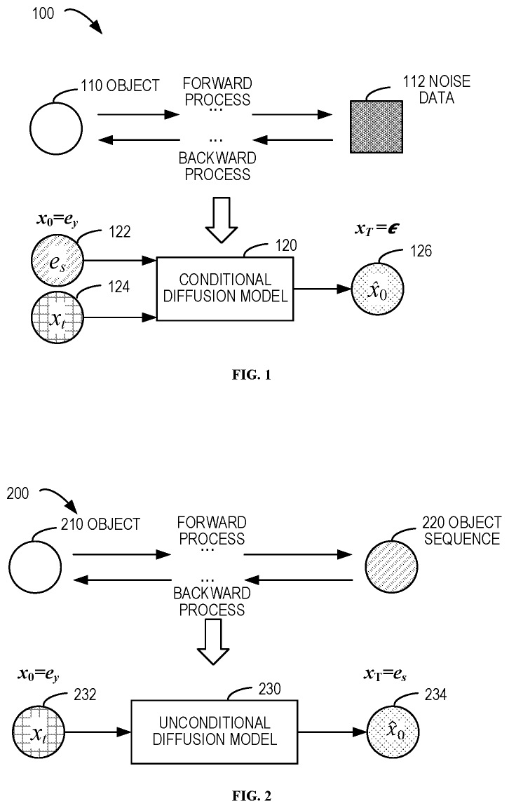

The overview of the recommendation process is described with reference to FIG. 1, which illustrates a block diagram 100 of using a diffusion model to recommend an object according to an implementation of the present disclosure. As shown in FIG. 1, a conditional diffusion model 120 may be used to perform a recommendation task. The conditional diffusion model 120 involves a forward process and a backward process. In the forward process, starting from an object 110, noise is gradually added to a feature of the object 110 in a plurality of noise addition steps to generate noise data 112. In the backward process, starting from the noise data 112 (for example, Gaussian noise), the noise is gradually removed in a plurality of denoising processes to recover the original feature of the object 110.

At this time, the state x₀ of the conditional diffusion model 120 may correspond to the feature e_{y} of the destination object to be recommended, and the state x_{T} may correspond to the noise data ϵ. In the backward process, x_{T} may be input to the conditional diffusion model 120, and the prediction \hat{x}₀ of the state x₀ is determined under the constraint of the condition es (representing the historical video sequence), and then the destination object to be recommended is determined. In other words, the conditional diffusion model 120 may recover the feature \hat{x}₀ of the destination object from the noise data ϵ under the conditional constraint of e_{S}.

However, the performance of the conditional diffusion model in recommendation tasks is not satisfactory. The conditional diffusion model originates from a text-guided image generation task, and the model cannot fully adapt to the unique characteristics of the recommendation system, resulting in poor performance. From the perspective of historical information utilization, the conditional diffusion model additionally focuses on the relationship between the destination object distribution and the Gaussian noise distribution, which may weaken the key relationship between the user's historical interaction and the destination object, thereby affecting the effect of personalized recommendation.

In addition, the main motivation for conditional design in text-to-image generation is to bridge the modal gap between text and image. However, for example, there is no modal difference in the recommendation system, and at this time, the conditional mechanism becomes a redundant burden and may introduce unnecessary learning complexity. In the recommendation task, the historical object sequence and the destination object itself are naturally aligned in the feature space. At this time, it is expected to provide a more accurate and effective diffusion model and determine the recommended object with higher efficiency.

### Overview of Object Recommendation

The diffusion model models the degradation (diffusion) process of data and reconstructs the original data using the backward process. It is expected to apply the diffusion model to object recommendation, that is, recommend objects based on the historical interaction between users and objects. A conditional diffusion framework has been proposed, in which in the forward process, the noise addition process is used to gradually add the features of the user history to the noise data; and in the backward process, the noise removal process relies not only on the noise data but also on the condition (that is, the sequence history) to generate the features of the destination object. This conditional diffusion framework allows the model to use historical information to generate features of the object to be recommended, ensuring that the model focuses on the recommendation task. Although the conditional diffusion framework may determine the recommended object from noise under the constraint of historical information, the framework does not consider the special requirements of the recommendation system. From the perspective of user history usage, the conditional diffusion framework focuses on modeling the relationship between user history and destination objects, thereby understanding personalized needs of the users. Since the object and Gaussian noise belong to different modalities, their feature spaces are different. The present disclosure expects to describe two endpoints of the diffusion model in the same modality, and thus an unconditional diffusion model may be used to describe the recommendation process.

In order to at least partially solve the deficiencies in the prior art, according to an implementation of the present disclosure, a method of determining an object to be recommended to a user is proposed, specifically, an unconditional diffusion process is used to model the recommendation process. The overview according to an implementation of the present disclosure is described with reference to FIG. 2, which illustrates a block diagram 200 of an overview of an unconditional diffusion model according to some implementations of the present disclosure. As shown in FIG. 2, the unconditional diffusion model 230 may establish an association relationship between “an object and a historical object sequence”. In the context of the present disclosure, the historical object sequence may also be referred to as user history, history, historical sequence, or sequence.

In order to model the relationship between “the object and the historical object sequence”, the key lies in designing a noise addition process that follows a constrained trajectory to gradually approach a specific endpoint. In contrast, the original diffusion process relies on random noise addition, resulting in scattered trajectories that cannot meet this goal. In order to address this challenge, the present disclosure proposes a new framework of Brownian Bridge Diffusion Recommendation (BBDRec). The core idea of the present disclosure is to use the Brownian bridge process to ensure the required constrained trajectory. Different from simply relying on random noise addition, the present disclosure adopts a structured noise addition process to guide the noise to gradually shift to historical representation through time-varying interpolation between the destination object and the historical representation. Empirical evaluation results on multiple public datasets demonstrate that the present disclosure exhibits superior performance in sequential recommendation tasks.

To this end, the present disclosure proposes an unconditional diffusion process for sequential recommendation. Instead of using the user history as a condition, the latent representation of the user history is directly used as the endpoint of the forward diffusion process and the starting point of the backward process. In this framework, the forward process represents the degradation of the destination object, guided by the historical object sequence, while the backward process decodes a specific object from this ambiguous state. The proposed technical solution may fully focus on the transformation between the destination object and the historical representation, thereby enabling more efficient use of historical information without the need to input conditions in the backward process. In the context of the present disclosure, the noise addition process may be combined with a constraint toward a specific endpoint, rather than a purely random noise addition process. Experiments on multiple public datasets consistently demonstrate the superior performance of the proposed technical solution in sequential recommendation tasks.

In summary, the key points of the proposed technical solution are as follows: an unconditional diffusion process is formulated for generative sequential recommendation, thereby directly modeling the “object-to-history” transformation while eliminating the need for conditional design. Furthermore, the Brownian bridge technique is used to enable the unconditional diffusion process for recommendation. At this time, the object sequence is not a conditional factor, but the features of the object sequence are directly used as the endpoint of the forward diffusion process and the starting point of the backward process. In this framework, the forward process represents the process of a specific object degrading to a “noise or fuzzy” state (represented by the sequence history) of user interests, while the backward process decodes the specific object from this fuzzy state. This architecture may focus on modeling the transformation relationship between the destination object distribution and the historical object distribution, thereby enabling more efficient use of historical information while eliminating the need to learn an explicit conditional mechanism.

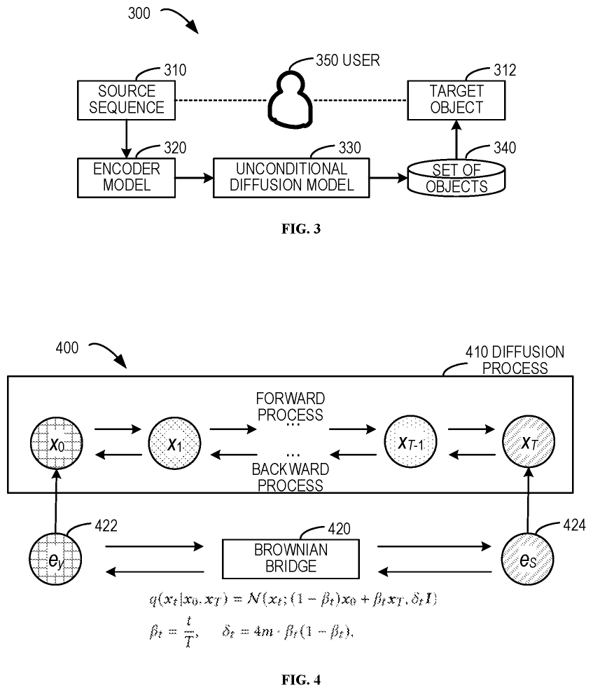

Further, the specific process of determining the destination object is described with reference to FIG. 3, which illustrates a block diagram 300 of determining an object to be recommended to a user using an unconditional diffusion model according to some implementations of the present disclosure. The set of objects may include a plurality of objects, and a user 350 may interact with at least one object (for example, the user plays a video). A source sequence 310 (for example, representing an interaction history between the user and the objects) may be obtained, and the source sequence 310 may include at least one source object associated with the user 350. An encoder model 320 may be used to determine a source feature corresponding to the source sequence 310. Here, the source feature is represented, for example, in the form of a feature (embedding), and the source sequence 310 is described in a feature space.

According to some implementations of the present disclosure, an unconditional diffusion model 330 may be constructed, which is implemented using a Brownian bridge architecture and describes an association relationship between a reference feature of a reference source sequence and a feature of a recommended reference destination object. In other words, the unconditional diffusion model 330 may use the Brownian bridge to directly establish an association relationship between the reference feature of the reference source sequence and the feature of the recommended reference destination object. Then, the unconditional diffusion model 330 may be used to map the source feature to a destination feature. That is, in the reverse inference phase, the model does not need to use the source sequence 310 as a condition to recover the destination object from noise, but may directly determine the features of the destination object from the features of the source sequence 310. Further, a destination object 312 matching the destination feature may be selected from the plurality of objects in the set of objects, and the destination object 312 may be recommended to the user 350.

### Detailed Process of Object Recommendation

For ease of description, the meanings of the terms used in the present disclosure are first provided. Suppose that [symbol] represents the collected user-object interaction data. A sample in [symbol] may be represented as (s, y)∈ [symbol] , where s represents a sequence history of interaction objects of a user within a specific period of time (for example, a few hours, a day, a week, etc.), and y represents a next object (that is, a destination object to be recommended) interacted by the user. The objective of the present disclosure is to train an unconditional diffusion model-based recommender using [symbol] , which is used to recommend a destination object at a next time point for the user in a generative manner from the entire set of objects. First, the current conditional diffusion recommendation framework is overviewed, which includes the following two key processes: a forward process (object-to-noise), and a backward process (noise-to-object|history). The backward process represents determining the object from noise under the constraint of the interaction history.

The forward process involves gradually perturbing the object of each sample, for example, for y in (s, y), this may be achieved by gradually introducing Gaussian noise in a plurality of time steps. Specifically, for each sample (s, y), the embedding of the destination object y is perturbed. Let x₀ represent the starting point of this process, that is, x₀=e_{y}. Then, x₀ is gradually perturbed in a plurality of time steps in the forward process, and the noise addition level is increased in a predetermined manner [α₁, . . . , α_{T}]. Here, T represents the maximum diffusion step. Formally, the transformation process at each step may be expressed as the following formula (1).

q(xₜ|xₜ₋₁)= [symbol] (xₜ;\sqrt{αₜ}xₜ₋₁,(1−αₜ)I) (1)

In the above formula, xₜ represents the noise representation at the noise level αₜ∈[0, 1]. By defining

$${\overline{α}}_{t} = {\prod }_{i = 1}^{t} {α}_{i} , {x}_{t} ,$$

it may be obtained through multi-step transformation:

q(xₜ+x₀)= [symbol] (xₜ;\sqrt{αₜ}x₀,(1−αₜ)I) (2)

Note that when T is large enough, the endpoint x_{T} may be approximately regarded as pure Gaussian noise. In the forward process, there is no need to optimize model parameters.

In the backward process, conditioned on the given user history s, the clear destination object embedding may be gradually reconstructed from the given random noise (x_{T}=ϵ). Given the feature at step t (that is, xₜ) and the history s, the feature at step t−1 (that is, xₜ₋₁) may be obtained through the following denoising process.

p_{θ}(xₜ₋₁|xₜ,s)= [symbol] (xₜ₋₁;\hat{μ}_{θ}(xₜ,t,s),Σ_{θ}(xₜ,t,s)) (3)

In the above formula, \hat{μ}_{θ}(xₜ, t, s) and Σ_{θ}(xₜ, t, s) are Gaussian parameters generated by a machine learning model with learnable parameters θ. In the backward process, the parameters θ need to be learned. This is done by maximizing the Evidence Lower Bound (ELBO), which is approximated by minimizing the following KL divergence: D_{KL}(q(xₜ₋₁|xₜ, x₀)∥p_{θ}(xₜ₋₁|xₜ, s)).

In the above formula, q(xₜ₋₁|xₜ; x₀) represents the posterior distribution, and there is the following relationship:

$$q ( {x}_{t - 1} \vert {x}_{t} , {x}_{0} ) = 𝒩 ( {x}_{t - 1} ; {μ}_{t} ( {x}_{t} , {x}_{0} ) , {σ}_{t}^{2} I ) , \qquad ( 4 )$$

$${μ}_{t} ( {x}_{t} , {x}_{0} ) = \frac{\sqrt{{α}_{t}} ( 1 - {\overline{α}}_{t - 1} )}{1 - {\overline{α}}_{t}} {x}_{t} + \frac{\sqrt{{\overline{α}}_{t - 1}} ( 1 - {α}_{t} )}{1 - {\overline{α}}_{t}} {x}_{0}$$

$${σ}_{t}^{2} = \frac{( 1 - {α}_{t} ) ( 1 - {\overline{α}}_{t - 1} )}{1 - {\overline{α}}_{t}} .$$

In order to ensure training stability and reduce computational complexity, Σ_{θ}(xₜ, t, s) in formula (3) is set to

$${σ}_{t}^{2} I .$$

This may simplify the KL divergence in the optimization process to align \hat{μ}_{θ}(xₜ, t, s), at this time, there is μₜ(xₜ, x₀). Following the definition μₜ(xₜ, x₀) in the formula, μ_{θ}(xₜ, t, s) in formula (3) may be determined by using the reparameterization process determined as follows.

$${\hat{μ}}_{θ} ( {x}_{t} , t , s ) = \frac{\sqrt{{α}_{t}} ( 1 - {\overline{α}}_{t - 1} )}{1 - {\overline{α}}_{t}} {x}_{t} + \frac{\sqrt{{\overline{α}}_{t - 1}} ( 1 - {α}_{t} )}{1 - {\overline{α}}_{t}} {f}_{θ} ( {x}_{t} , t , s ) \qquad ( 5 )$$

In the above formula, f_{θ}(⋅) represents the denoising model in the conditional diffusion model, which is used to predict x₀(x₀=e_{y}) based on the state in each diffusion step. Finally, the optimization may be performed by simply minimizing the MSE loss between x₀ and the model output f_{θ}(xₜ, t, s)

$${ℒ}_{sim} = {\sum }_{( s , 𝓎 ) ∈ 𝒟} {𝔼}_{t} [ {‖ {e}_{𝓎} - {f}_{θ} ( {x}_{t} , t , s ) ‖}_{2}^{2} ] \qquad ( 6 )$$

According to some implementations of the present disclosure, based on the principle of the conditional diffusion model, the Brownian bridge may be used to implement the unconditional diffusion model. According to some implementations of the present disclosure, an unconditional diffusion process is proposed to solve the problem that historical information cannot be fully utilized in conditional diffusion. In the unconditional diffusion process, the endpoint of the forward process and the starting point of the backward process are Gaussian noise. On this basis, the representation of the user history may be directly used as the endpoint of the forward process and the starting point of the backward process. At this time, the forward process is used to model the transformation from the object to the history, and the backward process is used to model the transformation from the history to the object.

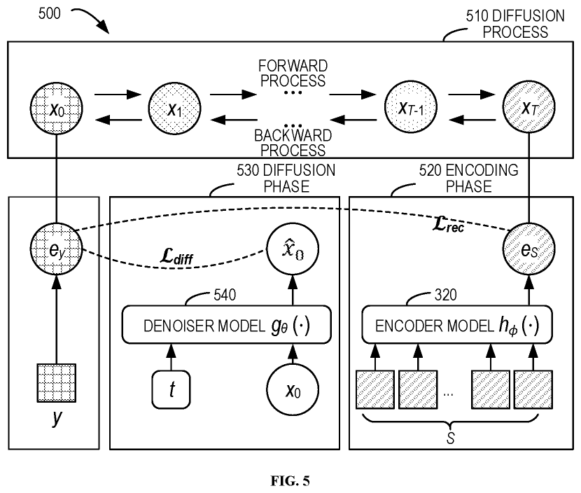

According to some implementations of the present disclosure, the unconditional diffusion process naturally and more effectively focuses on using historical information without introducing additional complexity, thereby enhancing the effect of using historical information without introducing additional complexity. In order to implement the unconditional process, a structured noise addition mechanism is provided, which converges to a specific point (user history) rather than pure noise. As shown in FIG. 4, the Brownian bridge may be used to implement unconditional diffusion.

More details are described with reference to FIG. 4, which illustrates a block diagram 400 of an unconditional diffusion process implemented based on a Brownian bridge according to some implementations of the present disclosure. As shown in FIG. 4, the Brownian bridge 420 may establish a mapping relationship between an object 422 (represented as the feature e_{y} of the destination object) and the history (represented as the feature eₛ of the historical object sequence). The Brownian bridge 420 may provide a noise addition and denoising mechanism to implement the unconditional diffusion process. Specifically, the Brownian bridge 420 may be combined with a structured noise addition process and ensure that the endpoint of the forward process reaches a specific point, that is, the feature of the user history (that is, x_{T}=eₛ). At each step t, instead of simply injecting noise as in formula (1), the transformation to the desired endpoint is actually controlled by making the transformation function dependent on x_{T}. Meanwhile, the backward process is adjusted to rely only on x_{T}=eₛ to recover the feature e_{y} of the destination object without aligning the noise addition process with the user history.

Regarding the Brownian bridge architecture, this architecture is designed to directly model the object-to-history relationship based on the Brownian bridge process. In order to transform x₀ to a specific endpoint x_{T} instead of random noise, the core process of the Brownian bridge is to allow the intermediate state at each step t to be gradually more affected by the endpoint x_{T}, which may be expressed as:

$$q ( {x}_{t} \vert {x}_{0} , {x}_{T} ) = 𝒩 ( {x}_{t} ; ( 1 - {β}_{t} ) {x}_{0} + {β}_{t} {x}_{T} , {δ}_{t} I ) \qquad ( 7 )$$

$${β}_{t} = \frac{t}{T} , {δ}_{t} = 4 m \cdot {β}_{t} ( 1 - {β}_{t} ) ,$$

In the case of t=0, xₜ~ [symbol] (xₜ; x₀, 0), and in the case of t=T, xₜ~ [symbol] (xₜ; x_{T}, 0), which indicates that the process converges to a specific endpoint. As t increases from 0 to T, the variance gradually increases and then decreases, and reaches the maximum value m in the case of t=T/2, which means the state with the highest noise. Therefore, the variance metric may be adjusted using the hyperparameter m.

More details are described with reference to FIG. 5, which illustrates a block diagram 500 of an unconditional diffusion process according to some implementations of the present disclosure. As shown in FIG. 5, the diffusion process 510 may involve an encoding phase 520 and a diffusion phase 530. The encoder model 320 may determine the feature eₛ as the starting point xₜ of the backward process, and the denoiser model 540 in the backward diffusion model may gradually denoise in a plurality of steps and generate the feature e_{y} corresponding to the destination object.

Based on the content in formula (7), the unconditional diffusion process may be implemented by modifying the transformation function of the forward process, and x₀=e_{y} (the destination object) and x_{T}=eₛ (the user history) may be set. In the forward process (object-to-history), the forward transformation probability of noise addition is affected by the previous state xₜ₋₁ and the endpoint state x_{T}=eₛ. The forward transformation probability in each step may be expressed as:

$$q ( {x}_{t} \vert {x}_{t - 1} , {x}_{T} ) = 𝒩 ( {x}_{t} ; {γ}_{t} {x}_{t - 1} + ( {β}_{t} - {γ}_{t} {β}_{t - 1} ) {x}_{T} , {\hat{δ}}_{t} I ) \qquad ( 8 )$$

$${γ}_{t} = \frac{1 - {β}_{t}}{1 - {β}_{t - 1}} , {\hat{δ}}_{t} = {δ}_{t} - {γ}_{t}^{2} {δ}_{t - 1} ,$$

The objective of the backward process (history-to-object) is to reconstruct x₀=e_{y} from x_{T}=eₛ through a plurality of steps. According to the Brownian bridge, each xₜ₋₁ is constructed based on xₜ and the endpoint x_{T}:

p_{θ}(xₜ₋₁|xₜ,x_{T})= [symbol] (xₜ₋₁;\hat{μ}_{θ}(xₜ,t,x_{T}),Σ_{θ}(xₜ,t,x_{T})) (9)

In the above formula, \hat{μ}_{θ}(xₜ, t, x_{T}) and Σ_{θ}(xₜ, t, x_{T}) are Gaussian parameters generated by a machine learning model generated with learnable parameters θ. Given xₜ>x_{T} and at step t, the ELBO may be maximized according to the above formula, thereby achieving the objective of optimizing θ. According to some implementations of the present disclosure, the optimization objective may be approximated by minimizing the KL divergence D_{KL}(q(xₜ₋₁|xₜ, x₀, x_{T})∥p_{θ}(ₜ₋₁|xₜ, x_{T})), where the posterior probability q(xₜ₋₁|xₜ, x₀, x_{T}) may be expressed as:

$$q ( {x}_{t - 1} \vert {x}_{t} , {x}_{0} , {x}_{T} ) = 𝒩 ( {x}_{t - 1} ; {μ}_{t} ( {x}_{t} , {x}_{0} , {x}_{T} ) , {δ}_{t} I ) , \qquad ( 10 )$$

$${μ}_{t} ( {x}_{t} , {x}_{0} , {x}_{T} ) = \frac{{δ}_{t - 1}}{{δ}_{t}} {γ}_{t} {x}_{t} + \frac{{\hat{δ}}_{t}}{{δ}_{t}} ( 1 - {β}_{t - 1} ) {x}_{0} + ( {β}_{t - 1} - \frac{{δ}_{t - 1}}{{δ}_{t}} {γ}_{t} {β}_{t} ) {x}_{T} ,$$

$${\hat{δ}}_{t} = \frac{{\hat{δ}}_{t} {δ}_{t - 1}}{{δ}_{t}} .$$

By setting the variance in formula (9) to match the variance (Σ_{θ}(xₜ, t, x_{T})=δₜI) here, based on the definition, the latent difference between q(xₜ₋₁|xₜ, x₀, x_{T}) and p_{θ}(xₜ₋₁|xₜ, x_{T}) increases from the mean. Therefore, the optimization objective becomes aligning \hat{μ}_{θ}(xₜ, t, x_{T}) with μₜ(xₜ, x₀, x_{T}) to maximize the ELBO. Based on the definition μₜ(xₜ, x₀, x_{T}) and using the reparameterization technique, \hat{μ}_{θ}(xₜ, t, x_{T}) may be expressed as:

$${\dot{μ}}_{θ} ( {x}_{t} , t , {x}_{T} ) = \frac{{δ}_{t - 1}}{{δ}_{t}} {γ}_{t} {x}_{t} + \frac{{\hat{δ}}_{t}}{{δ}_{t}} ( 1 - {β}_{t - 1} ) {g}_{θ} ( {x}_{t} , t ) + ( {β}_{t - 1} - \frac{{δ}_{t - 1}}{{δ}_{t}} {γ}_{t} {β}_{t} ) {x}_{T} , \qquad ( 11 )$$

According to some implementations of the present disclosure, in the process of determining the unconditional diffusion model, a reference sample may be obtained from a plurality of reference samples in a reference sample set, and the reference sample includes a reference source sequence and a reference destination object. Further, a diffusion loss may be determined based on the reference source sequence and the reference destination object in the reference sample, and the unconditional diffusion model may be updated using the diffusion loss. Specifically, the diffusion model may be updated based on the difference between the predicted value and the true value. In this way, the diffusion model may be updated in the direction of reducing the difference between the predicted value and the true value, thereby improving the accuracy of prediction.

According to some implementations of the present disclosure, in the process of determining the diffusion loss, the unconditional diffusion model may be used to determine the prediction of the reference destination object based on the reference source sequence, and the diffusion loss may be determined based on the difference between the reference destination object and the prediction of the reference destination object. In the above formula, g_{θ}(⋅) represents that the denoising model is used to predict x₀, which is usually implemented by multi-layer perception (MLP). Finally, the optimization objective of aligning \hat{μ}_{θ}(xₜ, t, x_{T}) with μₜ(xₜ, x₀, x_{T}) may be transformed into aligning g_{θ}(xₜ, t) with ₀. This may be achieved by directly minimizing the MSE loss between g_{θ}(xₜ, t) and x₀. The loss [symbol] _{diff} may be defined as:

$${ℒ}_{diff} = {\sum }_{( s , 𝓎 ) ∈ 𝒟} {𝔼}_{t} {‖ {e}_{𝓎} - {g}_{θ} ( {x}_{t} , t ) ‖}_{2}^{2} \qquad ( 12 )$$

It should be understood that unlike the denoising model f_{θ}(⋅) used in conditional diffusion, the denoising model g_{θ}(⋅) of the present disclosure does not need to use historical information as data.

According to some implementations of the present disclosure, the encoder model and the unconditional diffusion model may be updated based on the joint training mode. Specifically, the encoding weight of the encoding loss and the diffusion weight of the diffusion loss may be obtained, and the encoder model and the unconditional diffusion model may be updated jointly based on the encoding loss, the encoding weight, the diffusion loss, and the diffusion weight.

For the entire prediction process, in addition to introducing the denoising model in the diffusion, an encoder is required to process the user history and the destination object to generate eₛ and e_{y}. A sequence encoder model h_{φ}(⋅) (for example, SASRec) may be used as the encoder. Continuing to refer to FIG. 5, the encoder model 320 may receive a source sequence, which may include at least one historical object. At this time, the encoder model 320 may map the features of the source sequence to the feature space of a general object. That is, eₛ and e_{y} need to be aligned, and at this time, [symbol] may be used for encoding loss of the optimization encoder.

According to some implementations of the present disclosure, in the process of determining the encoder model, a reference sample is obtained from a plurality of reference samples in a reference sample set, the reference sample including a reference source sequence and a reference destination object; an encoding loss is determined based on the reference source sequence and the reference destination object; and the encoder model is updated using the encoding loss. Specifically, the similarity between eₛ and e_{y} may be determined, and the encoder model may be updated in the direction of maximizing the similarity. In this way, the difference between eₛ and e_{y} may be reduced, thereby improving the recommendation accuracy.

According to some implementations of the present disclosure, in the process of determining the encoding loss based on the reference source sequence and the reference destination object, the similarity between the reference source sequence and the reference destination object may be determined; an overall similarity is determined between the reference source sequence and a plurality of reference destination objects of a plurality of reference samples; and the encoding loss is determined based on the similarity and the overall similarity. With some implementations of the present disclosure, the encoding loss may be minimized. It is defined as follows, where [symbol] represents the entire set of objects.

$${ℒ}_{rec} = {\sum }_{( s , 𝓎 ) ∈ 𝒟} - log \frac{exp ( {e}_{s} \cdot {e}_{𝓎} )}{{\sum }_{{𝓎}^{′} ∈ 𝒱} exp ( {e}_{s} \cdot {e}_{{𝓎}^{′}} )} \qquad ( 13 )$$

In the above formula, the numerator part represents the similarity between eₛ and e_{y}, and the denominator part represents the sum of the similarities between eₛ and all objects y′ in the entire set of objects. In this way, the difference between eₛ and e_{y} may be minimized in a more accurate manner, thereby improving the recommendation accuracy.

According to some implementations of the present disclosure, the encoding weight of the encoding loss and the diffusion weight of the diffusion loss may be obtained; and the encoder model and the unconditional diffusion model may be updated jointly based on the encoding loss, the encoding weight, the diffusion loss, and the diffusion weight. Specifically, during training, in order to decouple the task of learning high-quality sequence representations eₛ and the task of learning the diffusion process, a multi-task learning strategy may be used. Then, the entire learning process may be performed in a multi-task manner, and the following objective function may be obtained:

[symbol]

=λ₁ [symbol] _{diff}+λ₂ [symbol] _{rec} (14)

In the above formula, λ₁ and λ₂ are coefficients used to balance the two parts of the loss, [symbol] _{diff} is the diffusion loss defined in formula (12), and [symbol] _{rec} is the loss used to optimize the encoder in formula (13). Since the denoising process starts from the user history representation x_{T}=eₛ, which is generated by a specific sequence encoder model, it is subsequently used in the optimization of the reconstruction loss and the diffusion model denoiser model. This design leads to training challenges and suboptimal performance. In order to solve this problem, a multi-task learning strategy may be adopted to perform optimization by using both the diffusion loss and the encoding loss.

According to some implementations of the present disclosure, in the process of jointly updating the encoder model and the unconditional diffusion model, the overall loss may be determined based on the encoding loss, the encoding weight, the diffusion loss, and the diffusion weight, and the encoder and the unconditional diffusion model may be updated using the overall loss. With some implementations of the present disclosure, the update gradient of each model may be determined separately in an associated manner, and then the updated model may be obtained.

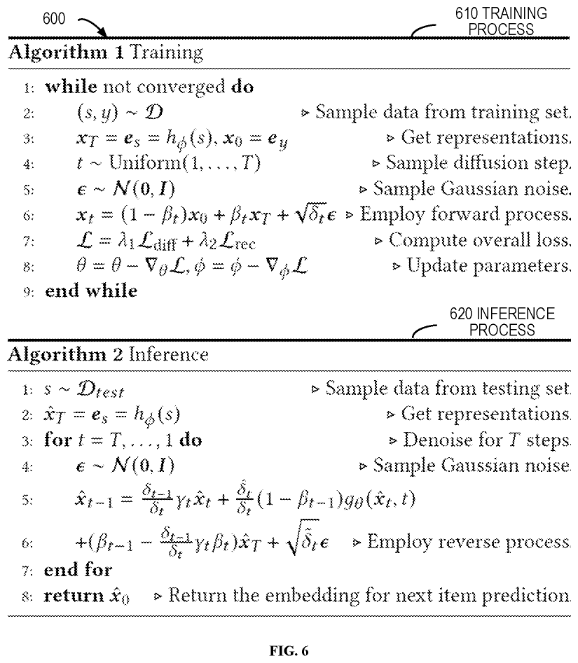

More details about the training model are described with reference to FIG. 6, which illustrates a block diagram 600 of an algorithm in a forward phase and a backward phase of an unconditional diffusion process according to some implementations of the present disclosure. It should be understood that FIG. 6 describes the overview of the algorithm in a pseudo-code format, and the above algorithm may be implemented in different development languages. As shown in FIG. 6, the training process 610 shows the algorithm used in the training process. At line 1, a predetermined convergence condition may be specified, and if the predetermined convergence condition is not reached, the steps at lines 2 to 8 are continuously executed. According to some implementations of the present disclosure, the training process involves iteratively updating the batch data. In each iteration process, the user history and the target item are sampled from the training set, and their representations are generated using the encoder model (lines 2-3). At line 2, data may be sampled from the training set, that is, a reference sample may be determined. At line 3, corresponding features may be determined based on the reference sample, and two endpoints of the unconditional diffusion model are specified respectively.

Then noise is introduced through the forward diffusion process based on formula (7), resulting in a noise representation at a randomly selected diffusion step (lines 4-6). Specifically, at line 4, the manner followed by the diffusion step may be specified. At line 5, Gaussian noise may be sampled. At line 6, the forward process may be performed. With the obtained intermediate state, the diffusion loss and the recommendation loss may be calculated using formula (12) and formula (14), respectively, which are then combined in formula (13) (line 7, the backward process is implicitly performed). Finally, the gradient is back propagated to update the parameters of the two models (line 8). Specifically, at line 7, the loss function for joint training may be determined according to the formula provided above. At line 8, the directions of the update gradients of the encoder model and the denoiser model may be determined based on the loss function, respectively, and then the encoder model and the denoiser model may be determined according to the corresponding update gradients, respectively.

The inference process 620 shows the various steps of the inference algorithm in the inference phase. At line 1, data may be sampled from the test set, that is, the user's historical object sequence s may be obtained. In the inference process, the model first processes the given user history, for example, its representation may be generated using the encoder model (line 2). Specifically, the encoder model may be used to determine the feature eₛ corresponding to the historical object sequence s as the starting point \hat{x}_{T} of the backward process.

Then, a backward diffusion process may be performed on this representation based on formula (9) and formula (11) to gradually remove noise in a plurality of steps to reconstruct the predicted representation of the target item. At each step, the noise reduction model refines the current state according to the learned dynamics (lines 3-6). According to some implementations of the present disclosure, a plurality of backward steps may be used to map the source feature to the destination feature. Specifically, in a first backward step of the plurality of backward steps of the unconditional diffusion model, the source feature is mapped to a first intermediate feature; and in response to determining that a second backward step after the first backward step does not reach an end point of the plurality of backward steps, the first intermediate feature is mapped to a second intermediate feature; and the first intermediate feature is replaced with the second intermediate feature. With some implementations of the present disclosure, the number of steps may be set based on a specific application environment.

In this way, the features that better match the destination object may be determined step by step in an iterative manner. Specifically, at line 3, the number of executions T of the backward step may be specified, and the denoising process may be iteratively performed in each backward step. At line 4, Gaussian noise may be sampled. At lines 5 to 6, the backward denoising process may be performed until the predetermined number of executions T is reached at line 7.

According to some implementations of the present disclosure, in response to determining that the second backward step reaches the end point of the plurality of backward steps, the first intermediate feature is used as the destination feature. In other words, when the predetermined convergence condition is reached, the iterative denoising process may end. At this time, the determined destination feature may correspond to an object in a plurality of candidate recommended objects. Specifically, at line 8, if the number of executions of the backward step reaches the predetermined number T, the iteration stops. At this time, the destination feature \hat{x}₀ of the destination object for the next object recommendation may be returned.

After generating the embedding prediction, the next step is to obtain the recommendation list customized for a specific user. According to some implementations of the present disclosure, the selecting, from the plurality of objects in the set of objects, the destination object matching the destination feature may include: determining the destination object based on distances between a plurality of features of the plurality of objects and the destination feature. Specifically, the K objects closest to the prediction are retrieved in the candidate set, and the inner product metric is used to form the recommendation list. For example, the K objects may be sorted according to the distances from near to far, and a recommendation list including the K recommended objects may be provided to the user. In this way, a plurality of recommended objects may be provided in an order that better matches the user's interests.

It would be appreciated that although the process of recommending a video to the user is described above only by taking the video as an example of the object. In the context of the present disclosure, the object may include, for example, but is not limited to, various types such as a video, a short video, an audio, an image, a text, a game, and an application. At this time, the application may include an application for providing a plurality of types of objects, and the source sequence may include one or more objects that have interacted with the user within a predetermined period of time in the past. Alternatively and/or additionally, the objects in the source sequence may include other users. The interaction may include various manners, such as playing, liking, following, forwarding, downloading, and so on. With some implementations of the present disclosure, different types of objects recommended to the user may be determined in a unified manner, thereby improving the recommendation efficiency.

According to some implementations of the present disclosure, the method described above may be performed in different public datasets, and experiments show that compared with existing technical solutions, the proposed unconditional diffusion model demonstrates superior generative capability. With the implementations of the present disclosure, the unconditional diffusion model may focus more on describing the transformation relationship between the destination object distribution and the historical object distribution, thereby making more effective use of historical information and determining the destination object in a more accurate and effective manner.

Regarding hyperparameter analysis, the proposed unconditional diffusion model involves two hyperparameters: m, T. Specifically, in formula (7), m controls the variance magnitude of the diffusion process, and T defines the maximum diffusion step. It may be seen from experimental analysis that the value of m may be set in the range {1,1e−1, 1e−2, 1e−4, 1e−8}, and the range of T may be set in {5, 10, 20, 50, 100, 200, 500, 1000, 2000}.

Regarding robustness analysis, the proposed technical solution shows significantly greater relative performance improvement in dealing with popular items and short sequences than conventional methods. This finding emphasizes the general applicability of the generative diffusion framework in dealing with these challenging scenarios. Compared with existing technical solutions, the performance improvement of the proposed method in distinguishing popular objects from long-tailed objects is more obvious, which indicates that the proposed method effectively uses user history and contextual information to capture popular objects that the user is more interested in.

Regarding efficiency analysis, the main difference between the unconditional diffusion model and the conditional diffusion model lies in the multi-step iteration process during inference. Tests on a large number of public datasets show that the proposed unconditional diffusion model has a higher inference speed because there is no additional computation involving conditional constraints.

### Example Process

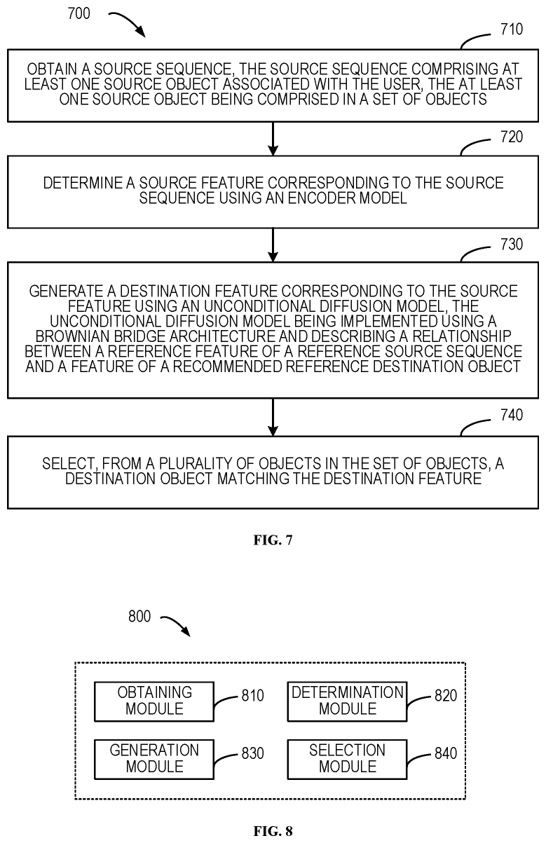

FIG. 7 shows a flowchart of a method 700 of determining an object to be recommended to a user according to some implementations of the present disclosure. At block 710, a source sequence is obtained, the source sequence including at least one source object associated with the user, the at least one source object being included in a set of objects. At block 720, a source feature corresponding to the source sequence is determined using an encoder model. At block 730, a destination feature corresponding to the source feature is generated using an unconditional diffusion model, the unconditional diffusion model being implemented using a Brownian bridge architecture and describing a relationship between a reference feature of a reference source sequence and a feature of a recommended reference destination object. At block 740, a destination object matching the destination feature is selected from a plurality of objects in the set of objects.

According to some implementations of the present disclosure, generating the destination feature corresponding to the source feature includes: in a first backward step of a plurality of backward steps of the unconditional diffusion model, mapping the source feature to a first intermediate feature; and in response to determining that a second backward step after the first backward step does not reach an end point of the plurality of backward steps, mapping the first intermediate feature to a second intermediate feature; and replacing the first intermediate feature with the second intermediate feature.

According to some implementations of the present disclosure, the method 700 further includes: in response to determining that the second backward step reaches the end point of the plurality of backward steps, using the first intermediate feature as the destination feature.

According to some implementations of the present disclosure, the encoder model is determined by: obtaining a reference sample from a plurality of reference samples in a reference sample set, the reference sample including a reference source sequence and a reference destination object; determining an encoding loss based on the reference source sequence and the reference destination object; and updating the encoder model using the encoding loss.

According to some implementations of the present disclosure, determining the encoding loss based on the reference source sequence and the reference destination object includes: determining a similarity between the reference source sequence and the reference destination object; determining an overall similarity, the overall similarity being between the reference source sequence and a plurality of reference destination objects of a plurality of reference samples; and determining the encoding loss based on the similarity and the overall similarity.

According to some implementations of the present disclosure, the unconditional diffusion model is determined by: determining a diffusion loss based on the reference source sequence and the reference destination object; and updating the unconditional diffusion model using the diffusion loss.

According to some implementations of the present disclosure, determining the diffusion loss includes: using the unconditional diffusion model, determining a prediction of the reference destination object based on the reference source sequence; and determining the diffusion loss based on a difference between the reference destination object and the prediction of the reference destination object.

According to some implementations of the present disclosure, the encoder model and the unconditional diffusion model are determined by: obtaining an encoding weight of the encoding loss and a diffusion weight of the diffusion loss; and jointly updating the encoder model and the unconditional diffusion model based on the encoding loss, the encoding weight, the diffusion loss, and the diffusion weight.

According to some implementations of the present disclosure, jointly updating the encoder model and the unconditional diffusion model includes: determining an overall loss based on the encoding loss, the encoding weight, the diffusion loss, and the diffusion weight; and updating the encoder and the unconditional diffusion model using the overall loss.

According to some implementations of the present disclosure, selecting, from the plurality of objects in the set of objects, the destination object matching the destination feature includes: determining the destination object based on distances between a plurality of features of the plurality of objects and the destination feature.

### Example Apparatus and Device

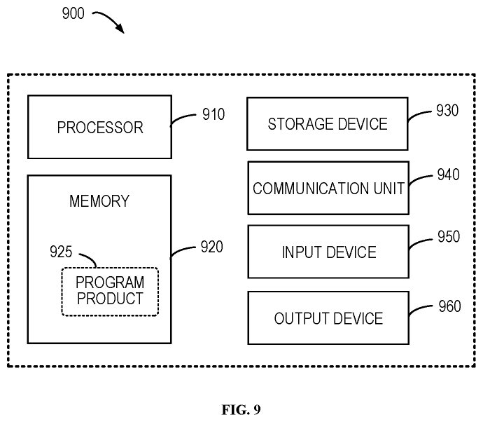

FIG. 8 shows a block diagram of an apparatus 800 for determining an object to be recommended to a user according to some implementations of the present disclosure. The apparatus 800 includes: an obtaining module 810 configured to obtain a source sequence, the source sequence including at least one source object associated with the user, the at least one source object being included in a set of objects; a determination module 820 configured to determine a source feature corresponding to the source sequence using an encoder model; a generation module 830 configured to generate a destination feature corresponding to the source feature using an unconditional diffusion model, the unconditional diffusion model being implemented using a Brownian bridge architecture and describing a relationship between a reference feature of a reference source sequence and a feature of a recommended reference destination object; and a selection module 840 configured to select a destination object matching the destination feature from a plurality of objects in the set of objects.

According to some implementations of the present disclosure, the generation module 830 is further configured to: in a first backward step of a plurality of backward steps of the unconditional diffusion model, map the source feature to a first intermediate feature; and in response to determining that a second backward step after the first backward step does not reach an end point of the plurality of backward steps, map the first intermediate feature to a second intermediate feature; and replace the first intermediate feature with the second intermediate feature.

According to some implementations of the present disclosure, the generation module is further configured to: in response to determining that the second backward step reaches the end point of the plurality of backward steps, use the first intermediate feature as the destination feature.

According to some implementations of the present disclosure, the apparatus 800 further includes: a processing module configured to obtain a reference sample from a plurality of reference samples in a reference sample set, the reference sample including a reference source sequence and a reference destination object; determine an encoding loss based on the reference source sequence and the reference destination object; and update the encoder model using the encoding loss.

According to some implementations of the present disclosure, the processing module is further configured to: determine a similarity between the reference source sequence and the reference destination object; determine an overall similarity, the overall similarity being between the reference source sequence and a plurality of reference destination objects of a plurality of reference samples; and determine the encoding loss based on the similarity and the overall similarity.

According to some implementations of the present disclosure, the processing module is further configured to: determine a diffusion loss based on the reference source sequence and the reference destination object; and update the unconditional diffusion model using the diffusion loss.

According to some implementations of the present disclosure, the processing module is further configured to: using the unconditional diffusion model, determine a prediction of the reference destination object based on the reference source sequence; and determine the diffusion loss based on a difference between the reference destination object and the prediction of the reference destination object.

According to some implementations of the present disclosure, the processing module is further configured to: obtain an encoding weight of the encoding loss and a diffusion weight of the diffusion loss; and jointly update the encoder model and the unconditional diffusion model based on the encoding loss, the encoding weight, the diffusion loss, and the diffusion weight.

According to some implementations of the present disclosure, the processing module is further configured to: determine an overall loss based on the encoding loss, the encoding weight, the diffusion loss, and the diffusion weight; and update the encoder and the unconditional diffusion model using the overall loss.

According to some implementations of the present disclosure, the selection module is further configured to: determine the destination object based on distances between a plurality of features of the plurality of objects and the destination feature.

FIG. 9 shows a block diagram of a device 900 capable of implementing various implementations of the present disclosure. It should be understood that the computing device 900 shown in FIG. 9 is only exemplary and should not constitute any limitation on the functions and scope of the implementations described herein. The computing device 900 shown in FIG. 9 may be used to implement the method described above.

As shown in FIG. 9, the computing device 900 is in the form of a general-purpose computing device. The components of the computing device 900 may include, but are not limited to, one or more processors 910, a memory 920, a storage device 930, one or more communication units 940, one or more input devices 950, and one or more output devices 960. The processor 910 may be an actual or virtual processor and may perform various processes based on the programs stored in the memory 920. In a multi-processor system, a plurality of processors execute computer executable instructions in parallel to improve the parallel processing capability of the computing device 900.

The computing device 900 typically includes a plurality of computer storage medium. Such medium may be any available medium that is accessible to the computing device 900, including, but not limited to, volatile and non-volatile medium, removable and non-removable medium. The memory 920 may be a volatile memory (for example, a register, a cache, a random access memory (RAM)), a non-volatile memory (such as a read-only memory (ROM), an electrically erasable programmable read-only memory (EEPROM), a flash memory), or any combination thereof. The storage device 930 may be any removable or non-removable medium, and may include a machine-readable medium such as a flash drive, a disk, or any other medium, which may be used to store information and/or data (such as training data for training) and may be accessed within the computing device 900.

The computing device 900 may further include additional removable/non-removable, volatile/non-volatile memory medium. Although not shown in FIG. 9, a disk drive for reading from or writing into removable and non-volatile disks (such as a “floppy disk”), and an optical disk drive for reading from or writing into removable and non-volatile optical disks may be provided. In these cases, each drive may be connected to a bus (not shown) by one or more data medium interfaces. The memory 920 may include a computer program product 925, which has one or more program modules configured to perform various methods or acts of various implementations of the present disclosure.

The communication unit 940 enables communication with other computing devices through the communication medium. Additionally, the functions of the components of the computing device 900 may be implemented by a single computing cluster or a plurality of computing machines, which may communicate through communication connections. Therefore, the computing device 900 may perform operations in a networked environment using a logical connection with one or more other servers, a network personal computer (PC), or another network node.

The input device 950 may be one or more input devices, such as a mouse, a keyboard, a tracking ball, etc. The output device 960 may be one or more output devices, such as a display, a speaker, a printer, etc. The computing device 900 may further communicate with one or more external devices (not shown) such as a storage device and a display device, communicate with one or more devices that enable the user to interact with the computing device 900, or communicate with any devices (such as a network card and a modem) that enable the computing device 900 to communicate with one or more other computing devices through the communication unit 940 as needed. Such communication may be performed via input/output (I/O) interfaces (not shown).

According to an implementation of the present disclosure, a computer-readable storage medium is provided, having computer executable instructions stored thereon, where the computer executable instructions are executed by a processor to implement the method described above. According to an implementation of the present disclosure, there is further provided a computer program product tangibly stored on a non-transitory computer-readable medium and including computer-executable instructions, which are executed by a processor to implement the method described above. According to an implementation of the present disclosure, a computer program product is provided, having a computer program stored thereon, where the program, when executed by a processor, implements the method described above.

Various aspects of the present disclosure are described herein with reference to flowcharts and/or block diagrams of methods, apparatuses, devices and computer program products implemented according to the present disclosure. It would be appreciated that each block of the flowcharts and/or block diagrams, and combinations of blocks in the flowcharts and/or block diagrams, may be implemented by computer-readable program instructions.

These computer-readable program instructions may be provided to a processor of a general-purpose computer, a special-purpose computer, or other programmable data processing apparatus to produce a machine, such that these instructions, when executed by the processor of the computer or other programmable data processing apparatus, produce an apparatus for implementing the functions/acts specified in one or more blocks of the flowcharts and/or block diagrams. These computer-readable program instructions may also be stored in a computer-readable storage medium, which instructions cause the computer, the programmable data processing apparatus, and/or other devices to work in a particular manner, so that the computer-readable medium storing the instructions includes an article of manufacture, which includes instructions for implementing various aspects of the functions/acts specified in one or more blocks of the flowcharts and/or block diagrams.

The computer-readable program instructions may be loaded onto a computer, another programmable data processing apparatus, or other devices, so that a series of operation steps are performed on the computer, the other programmable data processing apparatus, or the other devices to generate a computer-implemented process, such that the instructions executed on the computer, the other programmable data processing apparatus, or the other devices implement the functions/acts specified in one or more blocks of the flowcharts and/or block diagrams.

The flowcharts and block diagrams in the drawings show the possibly implemented architectures, functions and operations of the systems, methods and computer program products according to various implementations of the present disclosure. In this regard, each block in the flowchart or block diagram may represent a module, a program segment or a portion of instructions, which contains one or more executable instructions for implementing the specified logical functions. In some alternative implementations, the functions indicated in the blocks may also occur in an order different from that indicated in the drawings. For example, two consecutive blocks may actually be performed substantially in parallel, or they may sometimes be performed in the reverse order, depending on the functions involved. It would also be noted that each block of the block diagrams and/or flowcharts, and combinations of the blocks in the block diagrams and/or flowcharts, may be implemented by special purpose hardware-based systems that perform the specified functions or acts, or may be implemented by a combination of special purpose hardware and computer instructions.

Various implementations of the present disclosure have been described above, and the above description is exemplary, non-exhaustive, and not limited to the disclosed implementations. Many modifications and variations will be apparent to those of ordinary skill in the art without departing from the scope and spirit of the described implementations. The terms used herein are chosen to best explain the principles of the implementations, the practical applications or improvements to the technology in the market, or to enable others of ordinary skill in the art to understand the various implementations disclosed herein.

1. A method of determining an object to be recommended to a user, comprising:
obtaining a source sequence, the source sequence comprising at least one source object associated with the user, the at least one source object being comprised in a set of objects;
determining a source feature corresponding to the source sequence using an encoder model;
generating a destination feature corresponding to the source feature using an unconditional diffusion model, the unconditional diffusion model being implemented using a Brownian bridge architecture and describing a relationship between a reference feature of a reference source sequence and a feature of a recommended reference destination object; and
selecting, from a plurality of objects in the set of objects, a destination object matching the destination feature.

2. The method of claim 1, wherein generating the destination feature corresponding to the source feature comprises:
mapping, in a first backward step of a plurality of backward steps of the unconditional diffusion model, the source feature to a first intermediate feature; and
in response to determining that a second backward step after the first backward step does not reach an end point of the plurality of backward steps,
mapping the first intermediate feature to a second intermediate feature; and
replacing the first intermediate feature with the second intermediate feature.

3. The method of claim 2, further comprising: in response to determining that the second backward step reaches the end point of the plurality of backward steps, using the first intermediate feature as the destination feature.

4. The method of claim 1, wherein the encoder model is determined by:
obtaining a reference sample from a plurality of reference samples in a reference sample set, the reference sample comprising a reference source sequence and a reference destination object;
determining an encoding loss based on the reference source sequence and the reference destination object; and
updating the encoder model using the encoding loss.

5. The method of claim 4, wherein determining the encoding loss based on the reference source sequence and the reference destination object comprises:
determining a similarity between the reference source sequence and the reference destination object;
determining an overall similarity, the overall similarity being between the reference source sequence and a plurality of reference destination objects of the plurality of reference samples; and
determining the encoding loss based on the similarity and the overall similarity.

6. The method of claim 4, wherein the unconditional diffusion model is determined by:
determining a diffusion loss based on the reference source sequence and the reference destination object; and
updating the unconditional diffusion model using the diffusion loss.

7. The method of claim 6, wherein determining the diffusion loss comprises:
using the unconditional diffusion model, determining a prediction of the reference destination object based on the reference source sequence; and
determining the diffusion loss based on a difference between the reference destination object and the prediction of the reference destination object.

8. The method of claim 6, wherein the encoder model and the unconditional diffusion model are determined by:
obtaining an encoding weight of the encoding loss and a diffusion weight of the diffusion loss; and
jointly updating the encoder model and the unconditional diffusion model based on the encoding loss, the encoding weight, the diffusion loss, and the diffusion weight.

9. The method of claim 8, wherein jointly updating the encoder model and the unconditional diffusion model comprises:
determining an overall loss based on the encoding loss, the encoding weight, the diffusion loss, and the diffusion weight; and
updating the encoder and the unconditional diffusion model using the overall loss.

10. The method of claim 1, wherein selecting from the plurality of objects in the set of objects the destination object matching the destination feature comprises: determining the destination object based on distances between a plurality of features of the plurality of objects and the destination feature.

11. An electronic device, comprising:
at least one processor; and
at least one memory coupled to the at least one processor and storing instructions executable by the at least one processor, the instructions, when executed by the at least one processor, causing the electronic device to perform acts comprising:
obtaining a source sequence, the source sequence comprising at least one source object associated with the user, the at least one source object being comprised in a set of objects;
determining a source feature corresponding to the source sequence using an encoder model;
generating a destination feature corresponding to the source feature using an unconditional diffusion model, the unconditional diffusion model being implemented using a Brownian bridge architecture and describing a relationship between a reference feature of a reference source sequence and a feature of a recommended reference destination object; and
selecting, from a plurality of objects in the set of objects, a destination object matching the destination feature.

12. The device of claim 11, wherein generating the destination feature corresponding to the source feature comprises:
mapping, in a first backward step of a plurality of backward steps of the unconditional diffusion model, the source feature to a first intermediate feature; and
in response to determining that a second backward step after the first backward step does not reach an end point of the plurality of backward steps,
mapping the first intermediate feature to a second intermediate feature; and
replacing the first intermediate feature with the second intermediate feature.

13. The device of claim 12, wherein the acts further comprise: in response to determining that the second backward step reaches the end point of the plurality of backward steps, using the first intermediate feature as the destination feature.

14. The device of claim 11, wherein the encoder model is determined by:
obtaining a reference sample from a plurality of reference samples in a reference sample set, the reference sample comprising a reference source sequence and a reference destination object;
determining an encoding loss based on the reference source sequence and the reference destination object; and
updating the encoder model using the encoding loss.

15. The device of claim 14, wherein determining the encoding loss based on the reference source sequence and the reference destination object comprises:
determining a similarity between the reference source sequence and the reference destination object;
determining an overall similarity, the overall similarity being between the reference source sequence and a plurality of reference destination objects of the plurality of reference samples; and
determining the encoding loss based on the similarity and the overall similarity.

16. The device of claim 14, wherein the unconditional diffusion model is determined by:
determining a diffusion loss based on the reference source sequence and the reference destination object; and
updating the unconditional diffusion model using the diffusion loss.

17. The method of claim 16, wherein determining the diffusion loss comprises:
using the unconditional diffusion model, determining a prediction of the reference destination object based on the reference source sequence; and
determining the diffusion loss based on a difference between the reference destination object and the prediction of the reference destination object.

18. The device of claim 16, wherein the encoder model and the unconditional diffusion model are determined by:
obtaining an encoding weight of the encoding loss and a diffusion weight of the diffusion loss; and
jointly updating the encoder model and the unconditional diffusion model based on the encoding loss, the encoding weight, the diffusion loss, and the diffusion weight.

19. The device of claim 18, wherein jointly updating the encoder model and the unconditional diffusion model comprises:
determining an overall loss based on the encoding loss, the encoding weight, the diffusion loss, and the diffusion weight; and
updating the encoder and the unconditional diffusion model using the overall loss.

20. A non-transitory computer-readable storage medium having computer instructions stored thereon which, when executed by a processor, causes the processor to implement the acts comprising:
obtaining a source sequence, the source sequence comprising at least one source object associated with the user, the at least one source object being comprised in a set of objects;
determining a source feature corresponding to the source sequence using an encoder model;
generating a destination feature corresponding to the source feature using an unconditional diffusion model, the unconditional diffusion model being implemented using a Brownian bridge architecture and describing a relationship between a reference feature of a reference source sequence and a feature of a recommended reference destination object; and
selecting, from a plurality of objects in the set of objects, a destination object matching the destination feature.
